(19) United States
(12) Patent Application Publication
(10) Pub. No.: US 2026/0030987 A1
(43) Pub. Date: Jan. 29, 2026

(54) MOVE OVER / ONCOMNG VEHICLE WARNING SYSTEM

(71) Applicant: Mobile Video Computing Solutions LLC, Troy, MI (US)

(72) Inventors: D. Scott Watkins, Huntington Woods, MI (US); Craig A. Tieman, Punta Gorda, FL (US)

(73) Assignee: Mobile Video Computing Solutions LLC, Troy, MI (US)

(21) Appl. No.: 17/783,586

(22) PCT Filed: Nov. 5, 2021
(86) PCT No.: PCT/US2021/058263

§ 371 Date: Apr. 7, 2023

Related U.S. Application Data
(60) Provisional application No. 63/110,912, filed on Nov. 6, 2020.
(60) Provisional application No. 63/116,802, filed on Nov. 20, 2020.

(51) Int. Cl. G08G 1/16; G08G 1/017; G08G 1/04; G08G 1/052

(52) U.S. Cl. CPC G08G 1/166; G08G 1/0175; G08G 1/04; G08G 1/052; G08G 1/164

(57) ABSTRACT

A system for alerting a responder at a crash site to take evasive action to an on-coming motor vehicle move-over failure, having a processor, a sensor coupled to the processor, and an alerting device coupled to the processor. The sensor may be an imaging device, radar unit, or similar. The alerting device includes warning lights, a tactile device, and an audio unit for warning signals. The system detects an approaching vehicle, and with a longitudinal axis of a rescue vehicle determines a position angle line and spacing between the system and the approaching vehicle. Through a sequence of positions of the approaching vehicle, the processor determines the possibility of a collision based upon the change in the angle between the longitudinal axis and the position angle line and the approaching vehicle. A method of alerting a responder to a failure of an on-coming vehicle to move over is disclosed.

### CROSS REFERENCE TO RELATED APPLICATIONS

This application claims the benefit of U.S. Provisional Patent Application No. 63/110,912 filed Nov. 6, 2020 and entitled “Move Over/Oncoming Vehicle Warning System”, and of U.S. Provisional Patent Application No. 63/116,802 filed Nov. 20, 2020 and entitled “Move Over/Oncoming Vehicle Warning System”, and both are incorporated herein by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### TECHNICAL FIELD

The present invention relates to advance alerting and warning methods and devices for use by responders to motorists requiring roadside assistance and to crash events for detecting and alerting responders to possible oncoming motor vehicles. More particularly, the present invention relates to methods and devices for detecting oncoming motor vehicles that may be traveling on a failure-to-move-over path and possible crash with a responder or a responder's vehicle engaged in providing roadside or crash event assistance and for alerting and warning the responder to avoid such failure-to-move-over oncoming motor vehicle by taking evasive action.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

In recent years motor vehicle traffic involving passenger vehicles and truck motor transport vehicles has experienced reductions in per-mile accident rates even as the number of miles driven and vehicle speeds have increased. There are a number of reasons for increased traffic safety including safety equipment improvements in motor vehicles, improved roadways, traffic control devices, and driver training. Nevertheless, incidents and accidents involving car and truck motor vehicles continue to occur. These include vehicle-to-vehicle collisions as well as single vehicle accidents. Systems have been developed for detecting and responding promptly to accident sites for rendering medical assistance, crashed vehicle removal, and on-site traffic control.

U.S. Pat. No. 9,628,975 relates to an in-vehicle accident detection apparatus for detecting and reporting a possible crash event to which, under qualified circumstances, dispatches first responders include crash scene tow vehicles and operators and emergency services such as police and ambulance. U.S. Pat. No. 9,913,099 relates to an advanced central dispatch center that receives reports of possible and actual crash events and coordinates dispatch of first responders and collection of crash event data, images (still and video), and other crash event information. U.S. Pat. No. 10,623,899 relates to an escalation system for evaluating and handling a non-response to a possible crash event for again dispatching first responders in qualified circumstances.

While these systems provide for detection of possible accidents and response services subsequent to an accident, first responders and others at an accident site are subject to risks from further dangers. A major problem arises at sites of accidents or of disabled vehicles, which problems involve first responder vehicles and personnel who are rendering aid to or involving with a motorist and accident or disable vehicles. For example, a police vehicle, ambulance or tow truck may be positioned adjacent to or proximate a vehicle stopped or crashed on the side of a road. The first responders are moving about the site providing appropriate responder services. However, while the stopped vehicles are in this position on a roadway and first responders and others are moving about the site, a vehicle approaching on the same road may accidentally hit the stopped vehicle, or even worse, hit a person associated with the stopped vehicles. While many jurisdictions require drivers of on-coming vehicles to “move over” a lane from the stopped emergency vehicles, or slow to a lower speed, when passing an accident or emergency site, distracted drivers may fail to do so. Further, such drivers of on-coming vehicles may crash into the stopped vehicles or persons at the site causing further damages or personal injury or death. It would be advantageous to mitigate the damage that may be caused by a subsequent accident at a crash site prior to its occurrence by avoiding a person associated with the stopped vehicles from being hurt by failure of an on-coming vehicle to move over.

Accordingly, there is a need in the art for first responder safety and warning systems for detecting and warning as to move over failure/oncoming vehicle warning that pose possible danger of collision with the on-site motor vehicle of the first responder. It is to such need that the present invention is directed.

### BRIEF SUMMARY OF THE INVENTION

The present invention meets the need in the trade by providing a vehicle warning system for a rescue vehicle with regards to an approaching vehicle, the vehicle warning system comprises a sensor mounted to a rescue vehicle that is adapted to sense the position, speed and direction of movement of an approaching vehicle. The vehicle warning system also includes a processor coupled to the sensor. The processor provides a longitudinal axis of the rescue vehicle. The processor also determines a position angle line extending between the vehicle warning system and the approaching vehicle. The processor determines an angle between the longitudinal axis and the position angle line, and determines a sequence of positions of the approaching vehicle along the position angle line. The processor also determines the possibility of a collision between the approaching vehicle and the rescue vehicle based upon the change in angle between the longitudinal axis and the position angle line and the position of the approaching vehicle along the position angle line. The vehicle warning system also includes an alerting device coupled to the processor that creates an audio, visual, or tactile warning signal in response to the processor determining the likelihood of a collision between the approaching vehicle and the rescue vehicle.

In another aspect, the present invention provides a method of warning a rescue vehicle of a possible collision with an approaching vehicle comprises the steps of providing a sensor mounted to a rescue vehicle that is adapted to sense the position, speed and direction of movement of an approaching vehicle; providing a processor coupled to the sensor; determining a position angle line extending between the vehicle warning system and the approaching vehicle; determining a sequence of angles between the longitudinal axis and the position angle line and determining a sequence of positions of the approaching vehicle along the position angle line; determining the possibility of a collision between the approaching vehicle and the rescue vehicle based upon the change in angle between the longitudinal axis and the position angle line and the position of the approaching vehicle along the position angle line, and creating an audio, visual, or tactile warning signal in response to the processor determining the likelihood of a collision between the approaching vehicle and the rescue vehicle.

Objects, advantages, and features of the present invention will become readily apparent upon a reading of the following detailed description together with reference to the drawings.

### BRIEF DESCRIPTION OF THE DRAWINGS

FIG. 1 shows a schematic view of the vehicle warning system of the present invention, showing a vehicle approaching a response site from the rear relative to a response vehicle.

FIG. 2 shows a schematic view of the vehicle warning system of the present invention, showing a vehicle approaching a response site from the front relative to a response vehicle.

FIG. 3 shows a schematic view of the vehicle warning system of FIG. 1.

FIG. 4 shows a schematic view of the vehicle warning system of the present invention, showing a vehicle approaching a response site from the front relative to a response vehicle.

FIG. 5 shows a safety alert vest worn by a first responder at a response crash site and incorporating warning devices in an embodiment of the vehicle warning system for altering the first responder to take evasive action in response to a move-over failure of the operating approaching motor vehicle.

FIG. 6 shows a portable warning device for use by a first responder with an alternate embodiment of the vehicle warning system.

FIG. 7A shows a side view of another embodiment of the vehicle warning system of the present invention.

FIG. 7B shows a top plan view of the vehicle warning system of the present invention in an illustrative embodiment.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

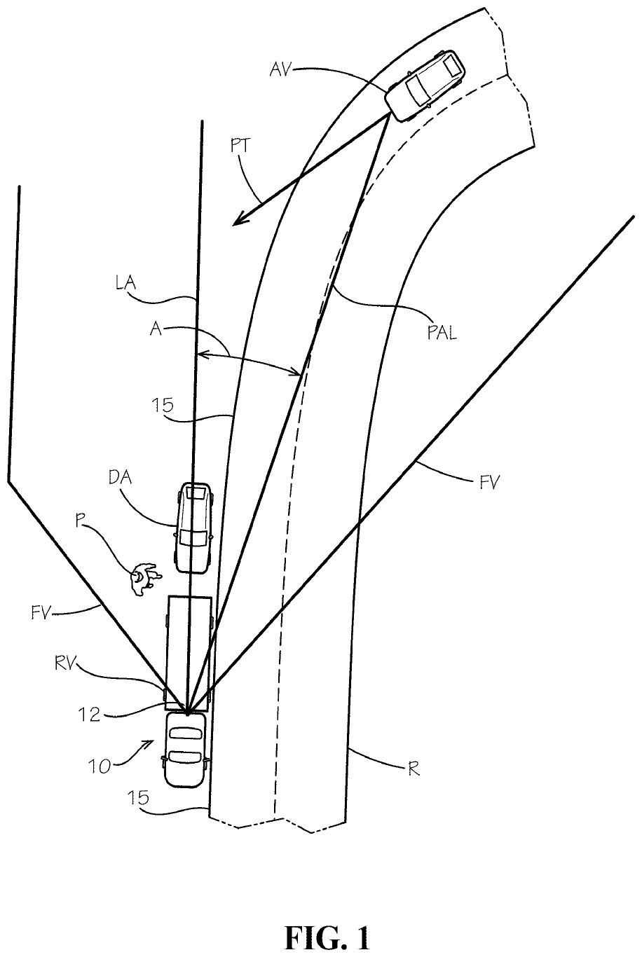

With reference next to the drawings, there is shown in FIG. 1 a vehicle warning system 10 in a preferred form of the invention. The vehicle warning system 10 is shown mounted to a responder vehicle RV illustrated parked along a road side 5 of a road R at a response site, such as a disabled motor vehicle DV or crash site of the disabled motor vehicle, which response site requires first responder personnel for assistance and/or disabled motor vehicle removal. The illustrated responder vehicle RV is a tow truck having a flat-bed for receiving and carrying a crashed or disabled vehicle; however, it should be understood that the vehicle warning system 10 may be mounted to any type of vehicle, especially a first responder vehicle RV such as a police vehicle, an emergency response fire truck, ambulance, or other accident site responder vehicle.

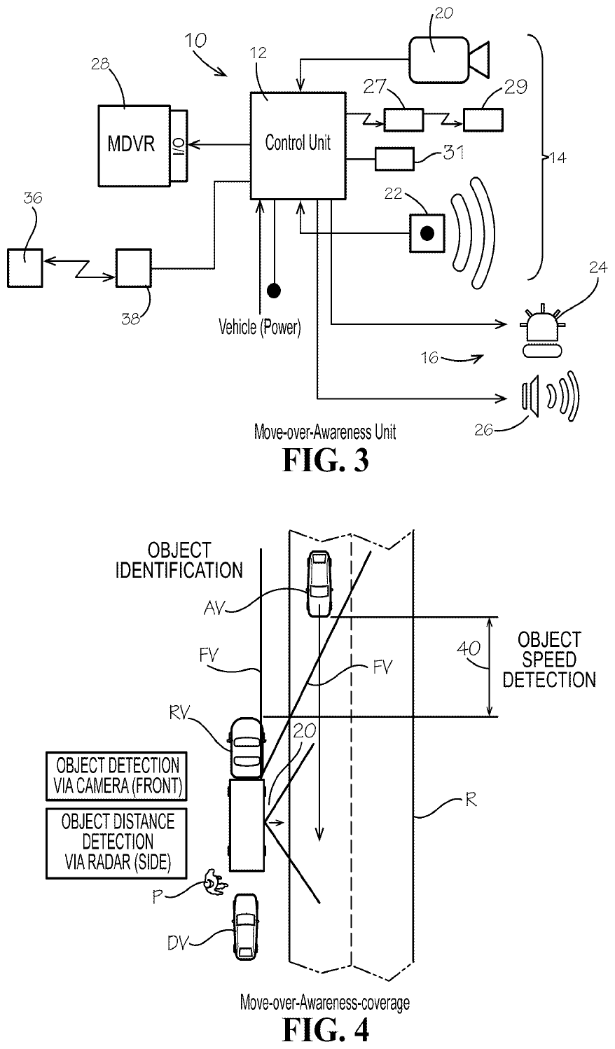

As shown in schematic view in FIG. 3, the vehicle warning system 10 includes a processor 12, a sensor 14 coupled to the processor 12, and an alerting device 16 coupled to the processor 12. The processor 12 may be a conventional microprocessor computer having application software instructions configured for operation of the vehicle warning system 10, including a microprocessor electronic chip, memory, input devices (mouse, keyboard, input response device) and a display. The vehicle warning system 10 is powered by the battery system of the first responder vehicle RV; however, it should be understood that the vehicle warning system 10 may alternatively utilize is own power source.

In the illustrated embodiment, the vehicle warning system 10 includes sensors 14 of an electronic imaging device 20 and a radar unit 22. The imaging device 20 may be oriented for imaging of an on-coming vehicle for license plate detecting and imaging and for imaging an edge of the roadway or traffic lane for the analysis of on-coming vehicle detection and warning. The imaging also may include information about the approaching on-coming vehicle for determining the color, model type, tires type, and other distinguishing features of the on-coming vehicle such as body damage if any, ornamentation symbols displayed on the vehicle, and signage, for example. The alerting device 16 in the illustrated embodiment includes one or more warning lights 24 and/or audio unit 26 for either or both visual and audio warning signals to the first responders and others at the accident site. A multiple digital recorder device 28 communicates with the processor 12 for recording on-coming vehicle data and alerting actions taken. The recorded data provides a log of crash site location, date, time, and events for further road and vehicle safety analysis, for possible use in insurance processing of damage claims through coordinated centralized data collection and distribution, and for possible use in accident and event occurrence review, reconstruction, and analysis.

In an alternate embodiment, the control unit 12 communicates with a communications device 31 configured for communicating through a communications network with a central dispatch center 27 for providing the recorded data. The communications network may be part of the world wide web network or a local area network using a communications device, or a cellular network such as accessed through a cellular module telephone transceiver device. Alternatively, the central dispatch center 27 may communicate recorded data with a local police authority 29; for example, communicating recorded motor vehicle tag information and recorded proximate images of the approaching motor vehicle AV and its operator's failure to move over away from the responder's vehicle, for possible enforcement actions by appropriate authorities; for example while the particular identified motor vehicle is in the relative proximity of the incident site.

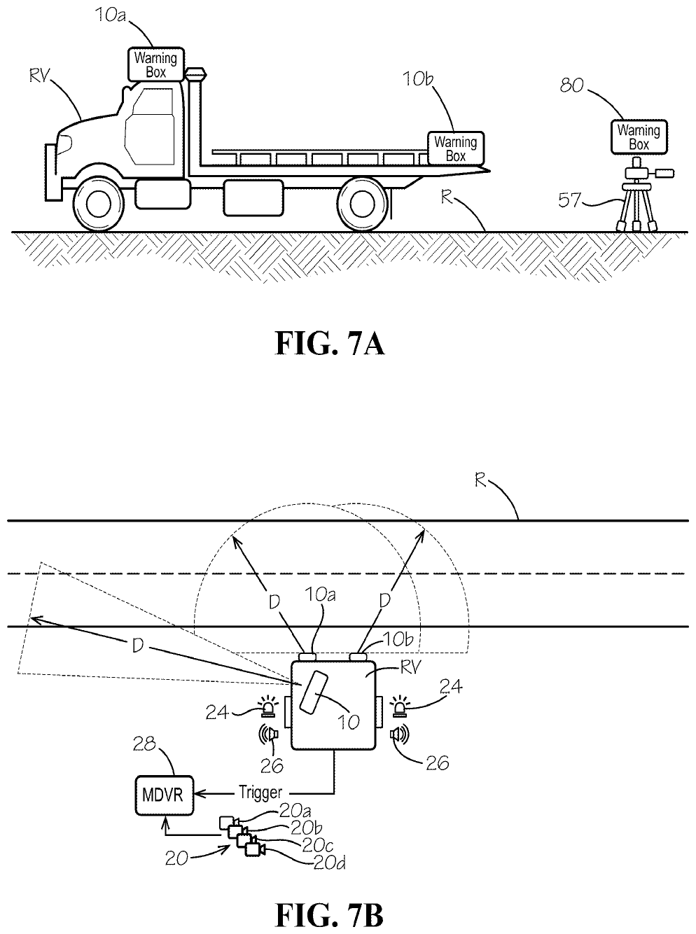

The sensor 14 may be in the form of an electronic imaging device, a motion detector, Light Detection and Ranging (Lidar) device, radar, V2X (vehicle-to-anything) radio frequency equipment, or the like, or a combination of such sensors, or multiple like sensors. The sensor 14, or the combination of the sensor 14 and processor 12, is capable of detecting the speed and direction of an approaching vehicle AV several hundred yards away from the vehicle warning system 10. The field of view of the sensor 14 is shown by the area between the field of view lines FV. Also, the sensor 14 may be capable of detecting the position and/or contour of the road R within the field of view. The road detection may be any conventionally known road detection system or software, which may recognize road markings, roadways, road contours, etc., as well as relative distances D between the location of the responder vehicle RV and an approaching vehicle AV. In an alternate embodiment, the first responder upon arriving at the site may selectively initialize the sensors as to the edge 15 of the road R or alternatively, the opposing edges. As shown in FIG. 7B, the vehicle warning system 10 may use one or more sensors, such as a plurality of imaging devices 20a-20d that communicate proximate images to the controller 12 and recording of respective images by the MDVR recorder 28. The imaging devices may be attached selectively to the rescue vehicle, for example with custom wiring harnesses connecting between the imaging devices and the control unit 12 or, alternatively, with wireless communication of imaging from the image devices and the control unit. FIG. 7B illustrates imaging devices mounted to a roof of a cab of a tow truck and two side mounted imaging devices. The imaging devices may be configured for particular imaging, for example, long and short range forward, rear and side views of the proximate site and approaching vehicles including imaging of vehicle license tag (front and/or rear mounted tags).

The alerting device 16 may be any audio, visual, or combination audio and visual device present at the crash site as mounted to the response vehicle RV or carried by a first responder P. For example, the alerting device 16 may be an alarm or alerting device, such as incorporating an audio alarm such as a horn, buzzer, siren, or loudspeaker, a visual alarm such as a light 44 or strobe, a tactile or physical contacting device such as a vibration device, or combination of such audio, visual, and tactile alarms for alerting the first responder. The alerting device 16 includes a receiver 36 that communicates with a transmitter 38 operated by the processor 12. The processor 12, upon determining that an approaching vehicle AV poses a possible crash risk, communicates a warning signal from the transmitter 38 to the receiver 36. The receiver 36 provides the one or more audio, visual alert, or tactile warning to the first responder P in order to take evasive safety action.

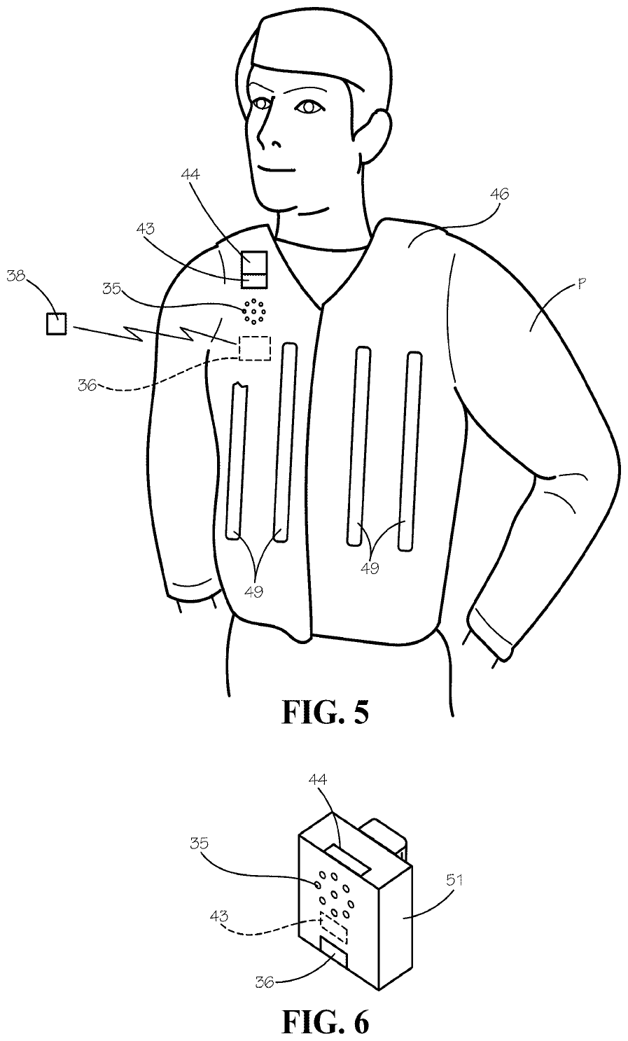

In an embodiment, the alerting device may be the receiver 36 and a speaker device 35 carried or worn on the person P of the first responder, which may incorporate the audio alarm such as a horn, buzzer, siren, or loudspeaker, the tactile alarm such as a vibrating device 43, or the a visual alarm such as the light 44 or strobe, or a combination. The receiver 36 communicates with the transmitter 38 operated by the processor 12. The processor 12, upon determining that an approaching vehicle AV poses a possible crash risk, communicates a warning signal from the transmitter 38 to the receiver 36. The receiver 36 provides the audio, tactic or visual alert to the first responder P in order to take evasive safety action. The receiver/speaker device 36 may be incorporated into a vest 46, as shown in FIG. 5, or may be a separate unit 51 removably mounted to the vest 46 or other article of clothing, as shown in FIG. 6 or carried by the first responder such as with a clip for securing the alert device 51 in a pocket. The alerting device thus may be a device remote from the processor and configured for wireless communication with the processor. The vest 46 may include reflective strips generally 49 for a safety vest for first responders, which reflective strips 49 reflect light such as from headlights of approaching vehicles or other light devices in use at the crash site. In an alternate embodiment, a central dispatch center may provide direct instructions to the first responder P by communicating through a telecommunications network with the warning system 10. The warning system 10 communicates the instructions from the central dispatch center to the receiver 36 for presentation by the speaker 35. The separate warning unit 51 may be embodied in a mobile communications device such as a cellular telephone, tablet, or other portable microprocessor device. In such embodiment, the alerting features are activated by software application instructions executed by the processor.

The processor 12 is programmed with software that is capable of determining a future position of an approaching vehicle AV based on the approaching vehicle's present speed/velocity and movement based on a determined sequence of sensed positions, and on centrifugal forces applied to the approaching vehicle based on these factors, in an object/speed detection zone 40 within the field of view FV in a proximate range of the warning system 10. FIG. 4 shows a schematic view of the vehicle warning system 10 of the present invention, showing the approaching vehicle AV approaching from the front into the object/speed detection zone 40 during operation of the warning system 10. The imaging device 20 provides a lateral side edge of the road R relative to the responder vehicle RV.

The processor 12 also determines the position of the first responder vehicle RV utilizing the location of the vehicle warning system 10 and a longitudinal axis extending along the longitudinal axis LA of the responder vehicle. As such, the processor 12 may determine if the approaching vehicle AV will likely leave the road R and strike the disabled automobile DA or the first responder vehicle RV, or persons proximate the site, based on the projected trajectory PT of the approaching vehicle AV.

The projected trajectory PT is based on general factors relating to the calculation of a trajectory, such as an average vehicle's weight, average vehicle's handling capabilities, average road conditions, etc. The projected trajectory PT may be calculated using a sequence of sensed positions of the approaching vehicle AV, the angle A between the responder vehicle RV longitudinal axis LA and the position angle line PAL extending between the vehicle warning system 10 and the approaching vehicle AV, and the position of the approaching vehicle AV along the position angle line PAL (distance on the position angle line PAL between the responder vehicle RV and approaching vehicle AV). The software of the processor 12 may also be programmed to determine the contour of the road ahead of the responder vehicle to refine the projected future positions of the approaching vehicle AV and its path along the existing road or contour of the road.

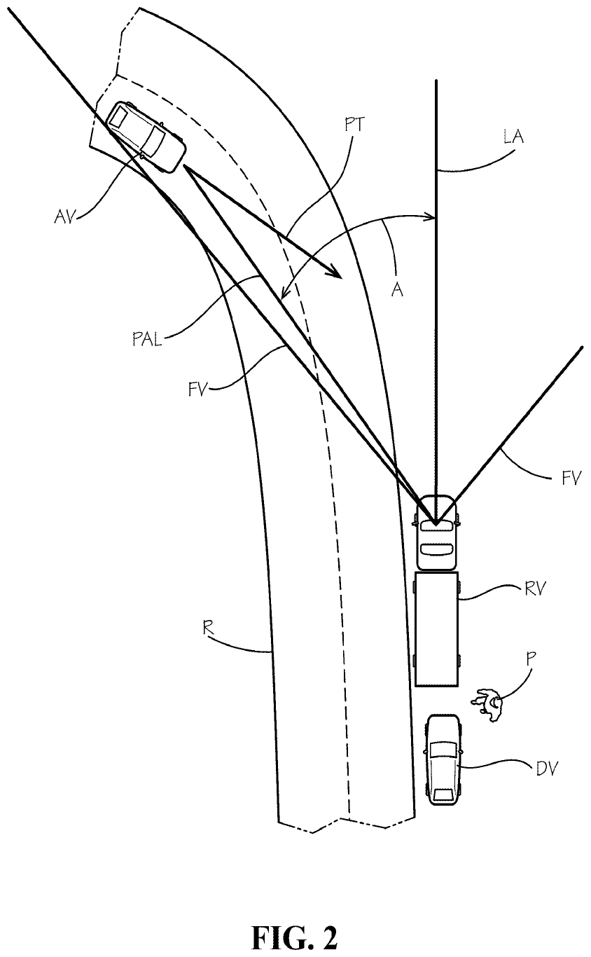

In use, the vehicle warning system 10 mounts to the responder vehicle RV so as to monitor the rear of the responder vehicle RV, as shown in FIG. 1, and/or to monitor the front of a responder vehicle, as shown in FIG. 2. Alternatively, the vehicle warning system 10 may be a remote unit 80 which is detachable and set up remotely from the responder vehicle RV, as shown in FIG. 7A, attached to a stand 57 such as a tripod. The stand 57 may be a fixed height, or feature an elevatable mount for selective elevational positioning of the vehicle warning system 10 for imaging.

As the responder vehicle RV is typically positioned parallel to the road R when attending to a call, the longitudinal axis of the responder vehicle RV produces the longitudinal axis LA for the vehicle warning system 10. The vehicle warning system 10 is automatically actuated so that the traffic monitoring immediately commences once the responder vehicle RA is parked. Alternatively, the first responder, such as a tow truck operator, may manually activate traffic monitoring of the vehicle warning system 10, including manual identification of site conditions for approaching vehicle detection and analysis. The vehicle warning system 10 constantly scans the field of view FV to detect any approaching vehicles AV.

Once an approaching vehicle AV is detected, the vehicle warning system 10 determines the position and speed of the approaching vehicle AV based on a timed series or sequence of detected imaged locations for the approaching vehicle AV within the field of view dist. Through this timed series of detected locations, the processor 12 may determine the projected trajectory PT based on a curve or line between the approaching vehicle AV, the longitudinal axis LA, and the speed of the approaching vehicle AV. The position of the approaching vehicle AV, the speed of the approaching vehicle AV, the angle A between the longitudinal axis LA and the position angle line PAL, and optionally the determined contour of the road R between the approaching vehicle AV and the responder vehicle RV, is utilized to calculate the possibility of an impending crash between the approaching vehicle AV and the area of the responder vehicle RV. Generally speaking, if the angle A between the longitudinal axis LA and the position angle line PAL decreases to near zero by the time the approaching vehicle AV is calculated to be at or within the select distance from the vehicle warning system 10, a crash is determined by the vehicle warning system 10 to be imminent.

Should the vehicle warning system 10 determine that the projected trajectory PT of the approaching vehicle AV is going to intersect the disabled automobile DA or responder vehicle RV, i.e., within a select distance D from the vehicle warning system 10, the processor 12 initiates an actuation signal to the alerting device 16. The actuation signal may be an electronic signal to operate the alerting device 16, or may be the direct energization of a power line actuating the alerting device 16. For example, the processor 12 may energize a light strobe to produce a flashing light, activate a vibration device, and/or an audio alarm to produce a loud noise indicative of an impending crash warning. The vehicle warning system 10 thereby may be configured with multiple avenues for alerting the first responder P of a possible danger.

The actuation of the alerting device 16 alerts the first responder driver/person P of the responder vehicle RV and further alerts others at the accident site such as the driver and passengers of the disabled automobile DA to the possibility of an impending crash with a visual and/or audio alert. The alerting device 16 may mount to the responder vehicle such a permanent mount to a vehicle roof or a temporary mounting for example having a magnet to secure the device to the vehicle. In the embodiment illustrated in FIG. 5, the alerting device 16 comprises the safety vest 46 with the receiver 36 and speaker 35, and alternatively may include the vibrating device 43 and/or visual light 44, for alerting the first responder P. As such, the notification by the alerting device 16 allows that person P a short time opportunity to take shelter from or attempt evasive safety actions to avoid the path of the oncoming approaching vehicle AV.

It should be understood that the vehicle warning system 10 may be configured to have a single unit monitor the areas both behind and in front of the responder vehicle RV, rather than two separate components shown in FIGS. 1 and 2. Such a vehicle warning system 10 may be mounted to the roof of the responder vehicle RV. For example, the embodiment illustrated in FIG. 7A positions a first vehicle warning system 10a on the cab roof of the tow truck and a second vehicle warning system 10b on the tail end of the responder vehicle, illustrated as a flat-bed of the tow truck. Further, alternatively, the vehicle warning system 10 may be mounted on the portable stand 57 (alternatively, such as a third warning system).

In an embodiment, the vehicle warning system may be configured to attempt to alert the driver of the oncoming approaching vehicle of possible impending crash into the existing crash site. This may be accomplished with the warning lights and emitted sounds that may be observed by the driver of the approaching vehicle AV. In an alternate embodiment, a central controller tracks the location of the responder vehicle RV and uses signals communicated from the approaching vehicle AV to determine its proximity to the crash site. The signals may be the periodic identification signal communicated from a mobile communications device or cell phone to a cell service tower of a cell service provider. The central controller identifies the approaching vehicle by correlating the identification signal of the cellular device to the location of the responder vehicle RV and proximate area. If the location of the cell device associated with an identification code is determined to be proximate the responding vehicle RV, the processor 12 may cause a communication of a warning to the cell phone associated with identification code. The vehicle warning system 10 thereby promulgates a directed warning or alert message to the operator of the approaching vehicle AV to slow and avoid colliding with the responder vehicle RV or proximate persons on site; for example, the system 10 may cause the cell phone of the operator of the detected approaching vehicle to emit an audible “slow down-move over” directive.

In an embodiment, the vehicle warning system 10 uses the speed limit of the road for a risk determination factor. The speed limit may be manually entered by the first responder or alternatively obtained from a road routing system that provides speed limit data, for example, accessible through a communications network or internet to a road routing system provider. A risk determination factor may be a speed-position factor of the speed of the approaching vehicle and its position in a road lane relative to the road speed limit and proximity to the rescue vehicle. An approaching vehicle AV determined to be in lane and at or below the speed limit would be considered as having a speed-position of a first risk level or threat. An approaching vehicle AV determined to be in lane and above the speed limit would be considered as having a second risk level or threat, which second risk is greater than the first risk level. An approaching vehicle AV determined to be out of lane and above the speed limit would be considered as having a third risk level or threat, which third risk is greater than the second risk level.

In an embodiment, the warning system 10 uses one or more ambient conditions for a risk determination factor in evaluating approaching vehicle AV risk of crash into the accident site. The ambient conditions may be ambient environmental conditions including weather and road conditions. The ambient conditions may be manually entered by the first responder (for example, road condition lane width, road condition paved or unpaved, pavement type cement, asphalt, gravel, etc, road condition wet or dry, air temperature or range, precipitation or not), or weather conditions may be obtained from a weather condition information service provider (for example, a networked inquiry to an online information servicer).

It is to be appreciated that the warning system 10 may be provided as an OEM feature of a responder vehicle RV or provided as components installed aftermarket of the responder vehicle.

An embodiment of the oncoming motor vehicle detection and warning system would have use in security and military checkpoint or guard post applications, including guarded sites, fenced installations with limited entrance access points, mass block retaining and barrier wall systems, obstacle structure drive entranceways, and similar secured installations requiring observation, detection, and warning to persons in proximity at the site of possible oncoming failure-to-move over or failure-to-respond motor vehicles as safety and security threat to the checkpoint or installation or nearby proximate persons.

It should also be understood that the system 10 may provide a dual warning system wherein the system initially provides a first level warning to indicate the presence of an oncoming vehicle, which may be escalated to a second level warning if the approaching vehicle's projected trajectory PT is determined to indicate a collision within the selected distance. The first and second level warnings may be any sound visual, audio or tactic alarm, wherein a difference exists between the first and second level warnings. The first level warning may indicate the presence of the approaching vehicle even if that vehicle is traveling within an appropriate lane relative to the responders vehicle RV and/or the vehicle warning system 10. Alternatively, the system may initiate the first level warning and then halt or suppress the first level warning once a determination is made that the projected trajectory PT of the approaching vehicle AV will not strike the responder vehicle RV or disabled automobile DA. In the event the system determines the approaching vehicle AV has a projected trajectory PT indicating possible subsequent impact at the site to the responder vehicle, the second level warning may be communicated.

As such, a vehicle warning system for a responder or rescue vehicle with regards to an approaching vehicle, which comprises a sensor mounted to a rescue vehicle that is adapted to sense the position, speed and direction of movement of an approaching vehicle. The vehicle warning system also includes a processor coupled to the sensor. The processor provides a longitudinal axis of the rescue vehicle. The processor also determines a position angle line extending between the vehicle warning system and the approaching vehicle. The processor determines an angle between the longitudinal axis and the position angle line, and determines a sequence of positions of the approaching vehicle along the position angle line. The processor also determines the possibility of a collision between the approaching vehicle and the rescue vehicle based upon the change in angle between the longitudinal axis and the position angle line and the position of the approaching vehicle along the position angle line. This determinization may include an evaluation of threat level factors of the approaching vehicle as discussed above, including proximate position and speed relative to the posted speed limit for the road R, including the first, second, and third risk levels, as well as road surface conditions and proximate ambient environmental conditions. The vehicle warning system also includes an alerting device coupled to the processor that creates an audio, visual, or tactile warning signal in response to the processor determining the likelihood of a collision between the approaching vehicle and the rescue vehicle. Persons proximate the site are thereby altered to a need for prompt evasive actions.

A method of warning a rescue vehicle of a possible collision with an approaching vehicle comprises the steps of providing a sensor mounted to a rescue vehicle that is adapted to sense the position, speed and direction of movement of an approaching vehicle; providing a processor coupled to the sensor; determining a position angle line extending between the vehicle warning system and the approaching vehicle; determining a sequence of angles between the longitudinal axis and the position angle line and determining a sequence of positions of the approaching vehicle along the position angle line; determining the possibility of a collision between the approaching vehicle and the rescue vehicle based upon the change in angle between the longitudinal axis and the position angle line and the position of the approaching vehicle along the position angle line, and creating an audio, visual, or tactile warning signal in response to the processor determining the likelihood of a collision between the approaching vehicle and the rescue vehicle.

The vehicle warning system may also track the location and record video of all external events relative to the rescue vehicle so that it can provide recordings of all events which involve the vehicle warning system awareness. The vehicle warning system may also include custom designed mounting devices or mechanisms to mount the vehicle warning system to a rescue vehicle. Lastly, the vehicle warning system sensors which sense the safe passage of the approaching vehicle, which may be used to update the software associated with the processor, the contour of the road, capture an image of the rear license plate of the approaching vehicle, or the analysis of an impending collision. In an alternate embodiment, the control unit 12 communicates with the central dispatch 27. The central dispatch 27 may alternatively communicate the recorded images of the approaching motor vehicle, for example the imaged identification tag or license plate together with recorded imaging of the second and/or third level threat of collision with the responder vehicle RV imaged by the sensor 20 and recorded on the MDVR recorder 28 showing the move-over failure by the operator of the approaching motor vehicle AV for possible enforcement actions. Further the imaging may include information about the approaching on-coming vehicle for determining the color, model type, tires type, and other distinguishing features of the on-coming vehicle such as body damage if any, ornamentation symbols displayed on the vehicle, and signage, for example.

More particularly, the present invention provides a vehicle warning system for a rescue vehicle with regards to an approaching vehicle, the vehicle warning system, comprising a sensor adapted to sense the position, speed and direction of movement of an approaching vehicle; a processor coupled to said sensor, said processor providing a longitudinal axis of the rescue vehicle, said processor determining a position angle line extending between said vehicle warning system and the approaching vehicle, said processor determining an angle between said longitudinal axis and said position angle line, said processor determining a sequence of positions of the approaching vehicle along said position angle line, said processor determining the possibility of a collision between the approaching vehicle and the rescue vehicle based upon the change in angle between said longitudinal axis and said position angle line and the position of the approaching vehicle along said position angle line and in response to a determination of an impending collision producing an alert signal, and an alerting device coupled to said processor, said alerting device creating an audio, visual, or tactile warning signal in response to said alert signal from said processor.

Further, the processor of the vehicle warning system also determines the contour of the road between the approaching vehicle and the rescue vehicle and includes the contour in the determination of the possibility of an impending collision. Further, the sensor of the vehicle warning system is an imaging device, a motion detector, a light detection, or a radar. Further, the alerting device of the vehicle warning system is remote device operative for wireless communication with the processor. Further, the sensor of the vehicle warning may be disposed remote from the rescue vehicle such as on a portable stand.

Further, the vehicle warning system further comprises a communications device configured for communicating via a communications network. The processor configured for communicating with the communications device to an enforcement authority imaged data associated with a motor vehicle determined to be on a projected trajectory such that an alert signal is produced.

Further, the vehicle warning system evaluates at least one risk determination factor for determining the possibility of a collision between the approaching vehicle and the rescue vehicle. The at least one risk determination factor comprises one or more of the group of a speed-position of the approaching vehicle relative to a speed limit of the road and/or a lane position relative to the rescue vehicle, ambient environmental conditions, and ambient road conditions.

In an aspect, the vehicle warning system determines the possibility of a collision between the approaching vehicle and the rescue vehicle by including an evaluation of the speed-position of the approaching vehicle relative to a speed limit of the road as a first risk factor if the approaching vehicle is in an appropriate lane and below the road speed limit, a second risk factor if the approaching vehicle is in an appropriate lane and at or above the road speed limit, which second risk factor is greater than said first risk factor, and a third risk factor if the approaching vehicle is out of an appropriate lane and above the road speed limit, which third risk factor is greater than said second risk factor.

In an aspect, the vehicle warning system determines the possibility of a collision between the approaching vehicle and the rescue vehicle by including an evaluation of the ambient environmental conditions of the at least one risk determination factor based on at least one of precipitation and temperature.

In an aspect, the vehicle warning system determines the possibility of a collision between the approaching vehicle and the rescue vehicle by including an evaluation of the ambient road conditions of the at least one risk determination factor based on at least one of road paved or unpaved, pavement type of cement, asphalt, gravel, and road condition wet or dry.

More particularly, the present invention provides a vehicle warning system for a rescue vehicle with regards to an approaching vehicle, comprising a sensor being adapted to sense the position, speed and direction of movement of an approaching vehicle; a processor providing a longitudinal axis of the rescue vehicle, said processor having software for determining a sequence of position angles between said longitudinal axis and the current position of the approaching vehicle relative to said vehicle warning system; said processor also having software for initiating an alert signal upon determining through said sequence of sensed positions of the approaching vehicle that the position angle will approach zero when the approaching vehicle is within a select distance from said vehicle warning system, and an alerting device coupled to said processor, said alerting device creating an audio, visual, or tactile warning signal in response to receiving said alert signal from said processor.

Further, the processor of the vehicle warning system for a rescue vehicle also determines the contour of the road between the approaching vehicle and the rescue vehicle and includes the contour in the determination of the possibility of an impending collision. Further, the sensor of the vehicle warning system is an imaging device, a motion detector, a light detection, or a radar. Further, the alerting device of the vehicle warning system is remote device operative for wireless communication with the processor. Further, the sensor of the vehicle warning may be disposed remote from the rescue vehicle such as on a portable stand.

Further, the vehicle warning system for a rescue vehicle further comprises a communications device configured for communicating via a communications network. The processor configured for communicating with the communications device to an enforcement authority imaged data associated with a motor vehicle determined to be on a projected trajectory such that an alert signal is produced.

Further, the vehicle warning system for a rescue vehicle evaluates at least one risk determination factor for determining the possibility of a collision between the approaching vehicle and the rescue vehicle. The at least one risk determination factor comprises one or more of the group of a speed-position of the approaching vehicle relative to a speed limit of the road and/or a lane position relative to the rescue vehicle, ambient environmental conditions, and ambient road conditions.

In an aspect, the vehicle warning system for a rescue vehicle determines the possibility of a collision between the approaching vehicle and the rescue vehicle by including an evaluation of the speed-position of the approaching vehicle relative to a speed limit of the road as a first risk factor if the approaching vehicle is in an appropriate lane and below the road speed limit, a second risk factor if the approaching vehicle is in an appropriate lane and at or above the road speed limit, which second risk factor is greater than said first risk factor, and a third risk factor if the approaching vehicle is out of an appropriate lane and above the road speed limit, which third risk factor is greater than said second risk factor.

In an aspect, the vehicle warning system for a rescue vehicle determines the possibility of a collision between the approaching vehicle and the rescue vehicle by including an evaluation of the ambient environmental conditions of the at least one risk determination factor based on at least one of precipitation and temperature.

In an aspect, the vehicle warning system for a rescue vehicle determines the possibility of a collision between the approaching vehicle and the rescue vehicle by including an evaluation of the ambient road conditions of the at least one risk determination factor based on at least one of road paved or unpaved, pavement type of cement, asphalt, gravel, and road condition wet or dry.

More particularly, the present invention provides a method of warning a rescue vehicle of a possible collision with an approaching vehicle, comprising the steps of:
(a) providing a sensor mounted to a rescue vehicle that is adapted to sense the position, speed and direction of movement of an approaching vehicle;
(b) providing a processor coupled to the sensor;
(c) determining a position angle line extending between the vehicle warning system and the approaching vehicle;
(d) determining a sequence of angles between the longitudinal axis and the position angle line and determining a sequence of positions of the approaching vehicle along said position angle line;
(e) determining the possibility of a collision between the approaching vehicle and the rescue vehicle based upon the change in angle between the longitudinal axis and the position angle line and the position of the approaching vehicle along the position angle line, and
(f) creating an audio, visual, or tactile warning signal in response to the processor determining the likelihood of a collision between the approaching vehicle and the rescue vehicle.

Further, the method of warning also determines the contour of the road between the approaching vehicle and the rescue vehicle and includes the contour in the determination of the possibility of an impending collision. Further, the sensor of the method of warning is an imaging device, a motion detector, a light detection, or a radar. Further, the alerting device of the method of warning is remote device operative for wireless communication with the processor. Further, the sensor of the warning method may be disposed remote from the rescue vehicle such as on a portable stand.

Further, the method of warning a rescue vehicle further communicating with a communications device to an enforcement authority imaged data associated with a motor vehicle determined to be on a projected trajectory such that an alert signal is produced.

Further, the method of warning a rescue vehicle evaluates at least one risk determination factor for determining the possibility of a collision between the approaching vehicle and the rescue vehicle. The at least one risk determination factor comprises one or more of the group of a speed-position of the approaching vehicle relative to a speed limit of the road and/or a lane position relative to the rescue vehicle, ambient environmental conditions, and ambient road conditions.

In an aspect, the method of warning a rescue vehicle determines the possibility of a collision between the approaching vehicle and the rescue vehicle by including an evaluation of the speed-position of the approaching vehicle relative to a speed limit of the road as a first risk factor if the approaching vehicle is in an appropriate lane and below the road speed limit, a second risk factor if the approaching vehicle is in an appropriate lane and at or above the road speed limit, which second risk factor is greater than said first risk factor, and a third risk factor if the approaching vehicle is out of an appropriate lane and above the road speed limit, which third risk factor is greater than said second risk factor.

In an aspect, the method of warning system a rescue vehicle determines the possibility of a collision between the approaching vehicle and the rescue vehicle by including an evaluation of the ambient environmental conditions of the at least one risk determination factor based on at least one of precipitation and temperature.

In an aspect, the method of warning a rescue vehicle determines the possibility of a collision between the approaching vehicle and the rescue vehicle by including an evaluation of the ambient road conditions of the at least one risk determination factor based on at least one of road paved or unpaved, pavement type of cement, asphalt, gravel, and road condition wet or dry.

The foregoing discloses a responder's warning system in illustrative embodiments for responders at road sites of disabled vehicles and crashed vehicles for detecting and alerting as to on-coming vehicles and vehicles that fail to move-over from rescue vehicles on road sides detected as having trajectories leading to possible subsequent impact with the rescue vehicle, the disabled or crashed vehicle, or persons in proximity. While this invention has been described with particular reference to certain illustrative embodiments, variations and modifications can be made without departing from the spirit and scope of the invention.

What is claimed is:

1. A vehicle warning system for a rescue vehicle with regards to an approaching vehicle, the vehicle warning system, comprising:
a sensor adapted to sense the position, speed and direction of movement of an approaching vehicle;
a processor coupled to said sensor, said processor providing a longitudinal axis of the rescue vehicle, said processor determining a position angle line extending between said vehicle warning system and the approaching vehicle, said processor determining an angle between said longitudinal axis and said position angle line, said processor determining a sequence of positions of the approaching vehicle along said position angle line, said processor determining the possibility of a collision between the approaching vehicle and the rescue vehicle based upon the change in angle between said longitudinal axis and said position angle line and the position of the approaching vehicle along said position angle line and in response to a determination of an impending collision producing an alert signal, and
an alerting device coupled to said processor, said alerting device creating an audio, visual, or tactile warning signal in response to said alert signal from said processor.

2. The vehicle warning system as recited in claim 1, wherein said processor also determines the contour of the road between the approaching vehicle and the rescue vehicle and includes the contour in the determination of the possibility of an impending collision.

3. The vehicle warning system as recited in claim 1, wherein said sensor is an imaging device, a motion detector, a light detection, or a radar.

4. The vehicle warning system as recited in claim 1, wherein said alerting device is a remote alerting device.

5. The vehicle warning system as recited in claim 4, wherein said remote alerting device further comprises a wireless communication device for communicating with said processor.

6. The vehicle warning system as recited in claim 1, wherein said sensor is remote from the rescue vehicle.

7. The vehicle warning system as recited in claim 1, further comprising:
a communications device configured for communicating via a communications network; and
the processor configured for communicating with the communications device to an enforcement authority imaged data associated with the approaching vehicle determined to be on a projected trajectory such that an alert signal is produced.

8. The vehicle warning system as recited in claim 7, wherein the imaged data comprises a vehicle license plate image of the approaching vehicle.

9. The vehicle warning system as recited in claim 1, further comprising at least one risk determination factor for determining the possibility of a collision between the approaching vehicle and the rescue vehicle.

10. The vehicle warning system as recited in claim 9, wherein the at least one risk determination factor comprises one or more of the group of a speed-position of the approaching vehicle relative to a speed limit of the road and/or a lane position relative to the rescue vehicle, ambient environmental conditions, and ambient road conditions.

11. The vehicle warning system as recited in claim 10, wherein the speed-position of the approaching vehicle relative to a speed limit of the road is a first risk factor if the approaching vehicle is in an appropriate lane and below the road speed limit, a second risk factor if the approaching vehicle is in an appropriate lane and at or above the road speed limit, which second risk factor is greater than said first risk factor, and a third risk factor if the approaching vehicle is out of an appropriate lane and above the road speed limit, which third risk factor is greater than said second risk factor.

12. The vehicle warning system as recited in claim 10, wherein the ambient environmental conditions of the at least one risk determination factor comprises at least one of precipitation and temperature.

13. The vehicle warning system as recited in claim 10, wherein the ambient road conditions of the at least one risk determination factor comprises at least one of road paved or unpaved, pavement type of cement, asphalt, gravel, and road condition wet or dry.

14. A vehicle warning system for a rescue vehicle with regards to an approaching vehicle, comprising:
a sensor being adapted to sense the position, speed and direction of movement of an approaching vehicle;
a processor providing a longitudinal axis of the rescue vehicle, said processor having software for determining a sequence of position angles between said longitudinal axis and the current position of the approaching vehicle relative to said vehicle warning system;
said processor also having software for initiating an alert signal upon determining through said sequence of sensed positions of the approaching vehicle that the position angle will approach zero when the approaching vehicle is within a select distance from said vehicle warning system, and
an alerting device coupled to said processor, said alerting device creating an audio, visual, or tactile warning signal in response to receiving said alert signal from said processor.

15. The vehicle warning system as recited in claim 14, wherein said processor also determines the contour of the road between the approaching vehicle and the rescue vehicle.

16. The vehicle warning system as recited in claim 14, wherein said sensor is an imaging device, a motion detector, a light detection, or a radar.

17. The vehicle warning system as recited in claim 14, wherein said alerting device is a remote alerting device.

18. The vehicle warning system as recited in claim 17, wherein said remote alerting device further comprises a wireless communication device for communicating with said processor.

19. The vehicle warning system as recited in claim 14, wherein said sensor is remote from the rescue vehicle.

20. The vehicle warning system as recited in claim 14, further comprising:
a communications device configured for communicating via a communications network; and
the processor configured for communicating with the communications device to an enforcement authority imaged data associated with the approaching vehicle determined to be on a projected trajectory such that an alert signal is produced.

21. The vehicle warning system as recited in claim 20, wherein the imaged data comprises a vehicle license plate image of the approaching vehicle.

22. The vehicle warning system as recited in claim 14, further comprising at least one risk determination factor for determining the possibility of a collision between the approaching vehicle and the rescue vehicle.

23. The vehicle warning system as recited in claim 22, wherein the at least one risk determination factor comprises one or more of the group of a speed-position of the approaching vehicle relative to a speed limit of the road and/or a lane position relative to the rescue vehicle, ambient environmental conditions, and ambient road conditions.

24. The vehicle warning system as recited in claim 23, wherein the speed-position of the approaching vehicle relative to a speed limit of the road is a first risk factor if the approaching vehicle is in an appropriate lane and below the road speed limit, a second risk factor if the approaching vehicle is in an appropriate lane and at or above the road speed limit, which second risk factor is greater than said first risk factor, and a third risk factor if the approaching vehicle is out of an appropriate lane and above the road speed limit, which third risk factor is greater than said second risk factor.

25. The vehicle warning system as recited in claim 23, wherein the ambient environmental conditions of the at least one risk determination factor comprises at least one of precipitation and temperature.

26. The vehicle warning system as recited in claim 23, wherein the ambient road conditions of the at least one risk determination factor comprises at least one of road paved or unpaved, pavement type of cement, asphalt, gravel, and road condition wet or dry.

27. A method of warning a rescue vehicle of a possible collision with an approaching vehicle, comprising the steps of:
(a) providing a sensor mounted to a rescue vehicle that is adapted to sense the position, speed and direction of movement of an approaching vehicle;
(b) providing a processor coupled to the sensor;
(c) determining a position angle line extending between the vehicle warning system and the approaching vehicle;
(d) determining a sequence of angles between the longitudinal axis and the position angle line and determining a sequence of positions of the approaching vehicle along said position angle line;
(e) determining the possibility of a collision between the approaching vehicle and the rescue vehicle based upon the change in angle between the longitudinal axis and the position angle line and the position of the approaching vehicle along the position angle line, and
(f) creating an audio, visual, or tactile warning signal in response to the processor determining the likelihood of a collision between the approaching vehicle and the rescue vehicle.

28. The method as recited in claim 27, wherein in step (e) the method also includes determining the possibility of collision based upon the contour of the road between the approaching vehicle and the rescue vehicle.

29. The method as recited in claim 27, wherein in step (a) the sensor is an imaging device, a motion detector, a light detection, or a radar.

30. The method as recited in claim 27, wherein in step (f) the warning signal is created upon a remote alerting device.

31. The method as recited in claim 30, wherein in step (f) the remote alerting device further comprises a wireless communication device for communicating with said processor.

32. The method as recited in claim 27, further comprising the step of communicating with a communications device to an enforcement authority imaged data associated with the approaching vehicle determined to be on a projected trajectory such that an alert signal is produced.

33. The vehicle warning system as recited in claim 32, wherein the imaged data comprises a vehicle license plate image of the approaching vehicle.

34. The method as recited in claim 27, further comprising the step of evaluating at least one risk determination factor for determining the possibility of a collision between the approaching vehicle and the rescue vehicle.

35. The method as recited in claim 34, wherein the step of evaluating the at least one risk determination factor further comprises selecting one or more of the group of a speed-position of the approaching vehicle relative to a speed limit of the road and/or a lane position relative to the rescue vehicle, ambient environmental conditions, and ambient road conditions.

36. The method as recited in claim 35, wherein the speed-position of the approaching vehicle relative to a speed limit of the road comprises determining a first risk factor if the approaching vehicle is in an appropriate lane and below the road speed limit, a second risk factor if the approaching vehicle is in an appropriate lane and at or above the road speed limit, which second risk factor is greater than said first risk factor, and a third risk factor if the approaching vehicle is out of an appropriate lane and above the road speed limit, which third risk factor is greater than said second risk factor.

37. The method as recited in claim 35, wherein the ambient environmental conditions of the at least one risk determination factor comprises selecting at least one of precipitation and temperature.

38. The method as recited in claim 35, wherein the ambient road conditions of the at least one risk determination factor comprises selecting at least one of road paved or unpaved, pavement type of cement, asphalt, gravel, and road condition wet or dry.
